(19) United States
(12) Patent Application Publication
(10) Pub. No.: US 2014/0045138 A1
(43) Pub. Date: Feb. 13, 2014

(54) LINGUAL RETENTION DEVICE

(71) Applicants: Paul A. GANGE, Itasca, IL (US); James Hilgers, Mission Viejo, CA (US)

(72) Inventors: Paul A. GANGE, Itasca, IL (US); James Hilgers, Mission Viejo, CA (US)

(21) Appl. No.: 13/570,887

(22) Filed: Aug. 9, 2012

(51) Int. Cl. A61C 7/20

(52) U.S. Cl. 433/20; 433/24

(57) ABSTRACT

An exemplary embodiment of the present invention is directed to a malleable flattened rectangular lingual retainer wire that is configured to be integrally shaped and bonded to the inside surfaces of teeth for a prolonged period of time. The lingual retainer wire acts to secure the teeth to one another in a manner that provides precise root position control. The lingual retainer wire is a single strand of wire that has been flattened in order to reduce its profile allowing the lingual retainer wire to be placed on the inside of either the upper or lower incisor teeth without interfering with occlusion.

### BACKGROUND OF THE INVENTION

1. Field of the Invention

This invention relates to orthodontic treatment retention and/or perpetuation, and more particularly, to a malleable flattened retainer wire that is configured to be integrally shaped with and bonded to the lingual surfaces of teeth.

2. Description of Related Art

The holding of an orthodontic treatment result may be the most important part of the orthodontic treatment. Studies have shown that a durable, semi-permanent retention device may be the most effective means of maintaining a finished orthodontic treatment. For example, a rectangular flattened braided wire, generally indicated by reference numeral 10, as shown in FIGS. 2 and 3 has been previously used in orthodontics as a retention device. The rectangular flattened braided wire 10 is composed of a number of smaller wires 15 that have been woven or braided together to form the rectangular flattened braided wire 10. However, due to the construction of the rectangular flattened braided wire 10, the rectangular flattened braided wire 10 is prone to fraying and/or stretching over time, which severely limits its long term usefulness as a retention device. In particular, normal dental cleaning procedures such as flossing has been shown to cause cutting of the smaller wires 15, which promotes fraying of the rectangular flattened braided wire 10. Therefore, it is desirable to provide a retention device that can be used to maintain an orthodontic treatment without the limitations discussed above that are attendant upon the use of prior retention devices.

### SUMMARY OF THE INVENTION

The present invention is designed to overcome the above noted limitations that are attendant upon the use of conventional orthodontic retention devices and, toward this end, it contemplates the provision of a novel retention device made from malleable flattened rectangular metallic wire that can be integrally shaped and bonded to the inside surfaces of teeth for extended periods of time.

Accordingly, it is an object of the present invention to provide a retention device that serves to secure teeth one to another in a manner that is both comfortable and cleansable for the patient.

It is another object of the present invention to provide a retention device having a substantially rectangular configuration so that when the retention device is bonded to the surface of the teeth the retention device provides perceive root position control.

It is yet another object of the present invention to providing a retention device made from a single strand of wire that has been flattened so that the retention device has a low profile or thickness in order to allow the retention device to be placed on the inside of either the upper or lower incisors without the retention device interfering with the occlusion.

It is still another object of the present invention to provide a retention device that is configured to hold the space closure or prevent the opening of contacts between individual teeth.

It is yet another object of the present invention to provide a retention device that can be bonded in place in order to increase patient compliance after orthodontic treatments.

It is still another object of the present invention to provide a retention device that is fray resistant.

It is yet another object of the present invention to provide a retention device that can be maintained in the mouth for an extended period of time.

It is still anther object of the present invention to provide a retention device that offers suitable hygiene and comfort to allow the retention device to be used for long term fixed retention of orthodontic treatments.

It has now been found that the foregoing and related objects can be readily attained in an orthodontic retention device in accordance with an exemplary embodiment of the present invention that may be a lingual retainer wire that includes a first side having a rectangular configuration, and a second side positioned opposite the first side and having a shape substantially the same as the rectangular configuration of the first side.

In accordance with the exemplary embodiment of the present invention, the first side and the second side are made from a unitary piece of material.

In accordance with the exemplary embodiment of the present invention, the rectangular configuration of the first side has a length in a first direction and a height in a second direction substantially perpendicular to the first direction, and the length of the rectangular configuration is greater than the height of the rectangular configuration.

In accordance with the exemplary embodiment of the present invention, the lingual retainer wire may also include a perimeter edge surrounding the rectangular configuration of the first side and positioned to connect the first side with the second side, and the perimeter edge has a profile that is less than the length and the height of the rectangular configuration.

In accordance with the exemplary embodiment of the present invention, the lingual retainer wire is configured and dimensioned for adhesion to a lingual side of at least two teeth by a bonding agent.

In accordance with the exemplary embodiment of the present invention, the lingual retainer wire is configured to hold a space closure between the at least two teeth when the lingual retainer wire is adhered to the lingual side of the at least two teeth.

In accordance with the exemplary embodiment of the present invention, the height of the rectangular configuration is between 0.5 and 1.0 mm, and wherein the profile of the perimeter edge is between 0.1 and 0.4 mm.

In accordance with the exemplary embodiment of the present invention, the unitary piece of material is a single strand of a flattened wire.

In accordance with the exemplary embodiment of the present invention, the unitary piece of material is made of a malleable metal.

In accordance with the exemplary embodiment of the present invention, the malleable metal is made of a titanium alloy.

In accordance with the exemplary embodiment of the present invention, the titanium alloy is nickel free.

In accordance with the exemplary embodiment of the present invention, the malleable metal is made of a stainless steel.

In accordance with the exemplary embodiment of the present invention, the stainless steel is comprised of a 316L grade stainless steel.

According to another exemplary embodiment of the present invention, a method of maintaining an orthodontic treatment is provided, where the method includes providing a lingual retainer wire dimensioned for adhesion to a lingual side of at least two teeth by a bonding agent, and adhering the lingual retainer wire to the lingual side of the at least two teeth by the bonding agent.

In accordance with the exemplary embodiment of the present invention, the lingual retainer wire may include a first side having a rectangular configuration, and a second side positioned opposite the first side and having a shape substantially the same as the rectangular configuration of the first side.

In accordance with the exemplary embodiment of the present invention, the first side and the second side are made of a unitary piece of material.

In accordance with the exemplary embodiment of the present invention, the rectangular configuration of the first side has a length in a first direction and a height in a second direction substantially perpendicular to the first direction, and the length of the rectangular configuration is greater than the height of the rectangular configuration.

In accordance with the exemplary embodiment of the present invention, the lingual retainer wire may also include a perimeter edge surrounding the rectangular configuration of the first side and positioned to connect the first side with the second side, and the perimeter edge has a profile that is less than the length and the height of the rectangular configuration.

In accordance with the exemplary embodiment of the present invention, adhering the lingual retainer wire to the lingual side of the at least two teeth by the bonding agent may include applying the bonding agent to the lingual side of the at least two teeth, applying a first portion of the first side the lingual retainer wire to the bonding agent on the lingual side of a first tooth of the at least two teeth, and applying a second portion of the first side of the lingual retainer wire to the bonding agent on the lingual side of a second tooth of the at least two teeth.

In accordance with the exemplary embodiment of the present invention, the bonding agent may include a dental adhesive.

In accordance with the exemplary embodiment of the present invention, the lingual retainer wire is configured and dimensioned for adhesion to a lingual side of at least two teeth by a bonding agent.

In accordance with the exemplary embodiment of the present invention, the lingual retainer wire is configured to hold a space closure between the at least two teeth when the lingual retainer wire is adhered to the lingual side of the at least two teeth.

In accordance with the exemplary embodiment of the present invention, the height of the rectangular configuration is between 0.5 and 1.0 mm, and wherein the profile of the perimeter edge is between 0.1 and 0.4 mm.

In accordance with the exemplary embodiment of the present invention, the unitary piece of material is a single strand of a flattened wire.

In accordance with the exemplary embodiment of the present invention, the unitary piece of material is made of a malleable metal.

In accordance with the exemplary embodiment of the present invention, the malleable metal is made of a titanium alloy.

In accordance with the exemplary embodiment of the present invention, the titanium alloy is nickel free.

In accordance with the exemplary embodiment of the present invention, the malleable metal is made of a stainless steel.

In accordance with the exemplary embodiment of the present invention, the stainless steel is comprised of a 316L grade stainless steel.

Another exemplary embodiment of the present invention is directed to a lingual retainer wire in combination with at least two teeth for use in retaining an orthodontic treatment.

In accordance with the exemplary embodiment of the present invention, the lingual retainer wire includes a first side having a rectangular configuration, and a second side positioned opposite the first side and having a shape substantially the same as the rectangular configuration of the first side.

In accordance with the exemplary embodiment of the present invention, the first side and the second side are made from a unitary piece of material.

In accordance with the exemplary embodiment of the present invention, the rectangular configuration of the first side has a length in a first direction and a height in a second direction substantially perpendicular to the first direction, and the length of the rectangular configuration is greater than the height of the rectangular configuration. In accordance with the exemplary embodiment of the present invention, the lingual retainer wire may also include a perimeter edge surrounding the rectangular configuration of the first side and positioned to connect the first side with the second side, and the perimeter edge has a profile that is less than the length and the height of the rectangular configuration.

In accordance with the exemplary embodiment of the present invention, each tooth of the at least two teeth has a lingual side, and the lingual retainer wire is configured and dimensioned for adhesion to the lingual side of each of the at least two teeth by a bonding agent.

In accordance with the exemplary embodiment of the present invention, the lingual retainer wire is configured to hold a space closure between the at least two teeth when the lingual retainer wire is adhered to the lingual side of each of the at least two teeth.

In accordance with the exemplary embodiment of the present invention, the lingual retainer wire is configured and dimensioned for adhesion to a lingual side of at least two teeth by a bonding agent.

In accordance with the exemplary embodiment of the present invention, the lingual retainer wire is configured to hold a space closure between the at least two teeth when the lingual retainer wire is adhered to the lingual side of the at least two teeth.

In accordance with the exemplary embodiment of the present invention, the height of the rectangular configuration is between 0.5 and 1.0 mm, and wherein the profile of the perimeter edge is between 0.1 and 0.4 mm.

In accordance with the exemplary embodiment of the present invention, the unitary piece of material is a single strand of a flattened wire.

In accordance with the exemplary embodiment of the present invention, the unitary piece of material is made of a malleable metal.

In accordance with the exemplary embodiment of the present invention, the malleable metal is made of a titanium alloy.

In accordance with the exemplary embodiment of the present invention, the titanium alloy is nickel free.

In accordance with the exemplary embodiment of the present invention, the malleable metal is made of a stainless steel.

In accordance with the exemplary embodiment of the present invention, the stainless steel is comprised of a 316L grade stainless steel.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is a sketch of an exemplary retention device according to the present invention installed on teeth;

FIG. 2 is a front view of a prior art retention device;

FIG. 3 is a top plan view of the prior art retention device;

FIG. 4 is a front view of an exemplary retention device according to the present invention; and

FIG. 5 is a top plan view of the exemplary retention device according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

FIGS. 4 and 5 show an exemplary embodiment of a lingual retainer wire, generally indicated by reference numeral 50, that may be used as an orthodontic retention device according to the present invention. The lingual retainer wire 50 may include a first side 53 and a second side 55, and each of the first side 53 and the second side 55 has a substantially rectangular configuration. The first side 53 and the second side 55 are positioned as opposite sides of the lingual retainer wire 50. Accordingly, since the first side 53 and the second side 55 are positioned as opposite sides of the lingual retainer wire 50 it is understood that the lingual retainer wire 50 itself has a substantially rectangular configuration. Furthermore, each of the first side 53 and the second side 55 have a substantially smooth surface. By substantially smooth surface, it is understood that the surfaces of the first side 53 and the second side 55 are substantially free from surface texture, but does not require a surface free of imperfections, such as a polished surface. However, it is understood that the substantially smooth surfaces of the first side 53 and the second side 55 may include polished surfaces.

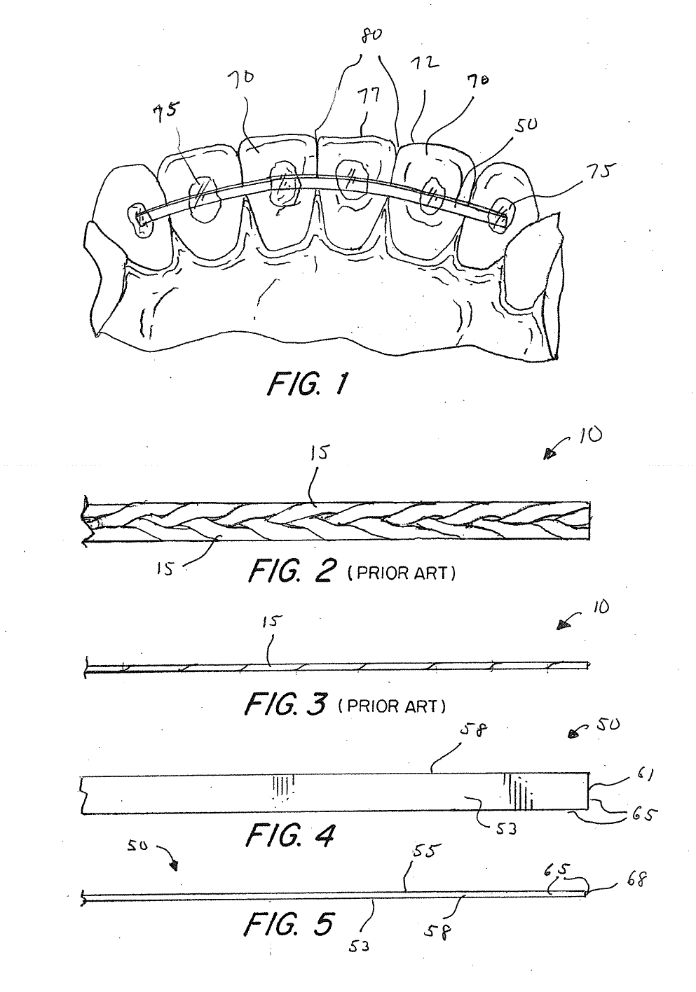

Still referring to FIGS. 4 and 5, the first side 53 and the second side 55 of the lingual retainer wire 50 are formed on a unitary piece of material that makes up the lingual retainer wire 50. This is in contrast to previous retention devices, as shown for example in FIGS. 1 and 2, that are made up of a numeral of smaller wires 15. Accordingly, it is understood that the lingual retainer wire 50 is made from the unitary piece of material.

Referring again to FIGS. 4 and 5, the rectangular configurations of the first side 53 and the second side 55 each have a length 58 along a first direction, and a height 61 along a second direction positioned substantially perpendicular to the first direction. In an exemplary embodiment of the present invention, the length 58 of each of the rectangular configurations of the first side 53 and the second side 55 may be greater than the height 61 of the rectangular configurations. The lingual retainer wire 50 may also include a perimeter edge 65 surrounding the rectangular configurations of the first side 53 and the second side 55 and connecting the first side 53 with the second side 55. The perimeter edge 65 includes two substantially parallel portions that run the length 58 of the rectangular configuration, and two other substantially parallel portions that run the height 61 of the rectangular configurations. The perimeter edge 65 has a profile 68 that may be less than the length 58 and the height 61 of the rectangular configurations. The profile 68 of the perimeter edge 65 is positioned between the first side 53 and the second side 55. It is understood that while the perimeter edge 65 is shown in FIGS. 4 and 5 having a substantially flat surface, it is understood that the perimeter edge 65 may be configured with a rounded surface or a pointed surface so the lingual retainer wire 50 may have rounded edges or pointed edges.

The unitary piece of material that makes up the lingual retainer wire 50 may be made from a malleable metal, preferably a titanium alloy or a stainless steel. If the unitary piece of material is a titanium alloy, it may be even more preferable to have the unitary piece of material be made from a nickel free titanium allow. If the unitary piece of material is a stainless steel, it may be even more preferable to have the unitary piece of material be made from a 316L grade stainless steel. The unitary piece of material may be formed from a single strand of a flattened drawn wire. Accordingly, the lingual retainer wire 50 may be made from a drawn wire that has been rolled in order to flatten the drawn wire into the lingual retainer wire 50 having the configuration discussed above and shown in FIGS. 4 and 5.

It is understood that the size of the lingual retainer wire 50 may be any appropriate dimensions for installation to the lingual side of the teeth on either the top or bottom jaw. Preferably, the length 58 of the lingual retainer wire 50 may be between 3 and 20 cm, and even more preferably about 16 cm. Preferably, the height 61 of the lingual retainer wire 50 may be between 0.5 and 1.0 mm, and even more preferably about 0.702 mm. Preferably, the profile 68 of the lingual retainer wire 50 may be between 0.1 and 0.4 mm, and even more preferably about 0.235 mm.

The use and operation of the lingual retainer wire 50 will now be discussed by referring to FIG. 1. The lingual retainer wire 50 is configured for attachment to a lingual side 70 of a tooth 72 by a bonding agent 75 in order to bind the tooth 72 to an adjacent tooth 77 in order to hold a space 80 between the teeth 72, 77 in a closed orientation substantially the same as after an orthodontic treatment. The lingual retainer wire 50 is bonded to the adjacent teeth 72, 77 by the bonding agent 75 in order to prevent substantial movement of the teeth 72, 77 so that the desired effect of the orthodontic treatment is maintained.

The lingual retainer wire 50 can be used to maintain an orthodontic treatment by adhering the lingual retainer wire 50 to the lingual side 70 of at least two teeth 72, 77 by the bonding agent 75. The lingual retainer wire 50 may be adhered to the at least two teeth 72, 77 by applying the bonding agent 75 to the lingual side 70 of the at least two teeth 72, 77. Then a first portion of either the first side 53 of the second side 55 of the lingual retainer wire 50 may be applied to the bonding agent 75 on the lingual side 70 of one of the teeth 72, and then a second portion of either the first side 53 of the second side 55 (whichever side was already applied to the teeth) of the lingual retainer wire 50 may be applied to the bonding agent 75 on the lingual side 70 of another adjacent tooth 77. This process can be repeated until the lingual retainer wire 50 has been adhered to the desired number of consecutive teeth. It is understood that the bonding agent 75 may be applied directly to the lingual retainer wire 50 before the lingual retainer wire 50 is applied to the teeth 72, 77. The bonding agent 75 may be any suitable dental adhesive, and it preferably should have characteristics to allow the lingual retainer wire 50 to be securely bound to the teeth for a prolonged period of time in order to allow sufficient time to retainer the orthodontic treatment, but removable after the maintenance period of the orthodontic treatment has ended.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

1. A lingual retainer wire configured for use as an orthodontic retention device, comprising:
a first side having a solid rectangular configuration; and
a second side positioned opposite the first side and having a solid shape substantially the same as the solid rectangular configuration of the first side;
wherein the first side and the second side are comprised of a unitary piece of material;
wherein the solid rectangular configuration of the first side has a length in a first direction and a height in a second direction substantially perpendicular to the first direction;
wherein the length of the solid rectangular configuration is greater than the height of the solid rectangular configuration;
wherein the lingual retainer wire further comprises a perimeter edge surrounding the solid rectangular configuration of the first side and positioned to connect the first side with the second side; and
wherein the perimeter edge has a profile that is less than the length and the height of the solid rectangular configuration.

2. The lingual retainer wire according to claim 1, wherein the unitary piece of material is comprised of a malleable metal.

3. The lingual retainer wire according to claim 2, wherein the malleable metal is comprised of a titanium alloy.

4. The lingual retainer wire according to claim 3, wherein the titanium alloy is nickel free.

5. The lingual retainer wire according to claim 2, wherein the malleable metal is comprised of a stainless steel.

6. The lingual retainer wire according to claim 5, wherein the stainless steel is comprised of a 316L grade stainless steel.

7. The lingual retainer wire according to claim 1, wherein the lingual retainer wire is configured and dimensioned for adhesion to a lingual side of at least two teeth by a bonding agent.

8. The lingual retainer wire according to claim 7, wherein the lingual retainer wire is configured to hold a space closure between the at least two teeth when the lingual retainer wire is adhered to the lingual side of the at least two teeth.

9. The lingual retainer wire according to claim 1, wherein the height of the solid rectangular configuration is between 0.5 and 1.0 mm, and wherein the profile of the perimeter edge is between 0.1 and 0.4 mm.

10. The lingual retainer wire according to claim 1, wherein the unitary piece of material is a single solid strand of a flattened wire.

11. A method of maintaining an orthodontic treatment, comprising:
providing a lingual retainer wire dimensioned for adhesion to a lingual side of at least two teeth by a bonding agent; and
adhering the lingual retainer wire to the lingual side of the at least two teeth by the bonding agent;
wherein the lingual retainer wire comprises:
a first side having a solid rectangular configuration; and
a second side positioned opposite the first side and having a solid shape substantially the same as the solid rectangular configuration of the first side;
wherein the first side and the second side are comprised of a unitary piece of material;
wherein the solid rectangular configuration of the first side has a length in a first direction and a height in a second direction substantially perpendicular to the first direction;
wherein the length of the solid rectangular configuration is greater than the height of the solid rectangular configuration;
wherein the lingual retainer wire further comprises a perimeter edge surrounding the solid rectangular configuration of the first side and positioned to connect the first side with the second side; and
wherein the perimeter edge has a profile that is less than the length and the height of the solid rectangular configuration.

12. The method according to claim 11, wherein adhering the lingual retainer wire to the lingual side of the at least two teeth by the bonding agent comprises:
applying the bonding agent to the lingual side of the at least two teeth;
applying a first portion of the first side the lingual retainer wire to the bonding agent on the lingual side of a first tooth of the at least two teeth; and
applying a second portion of the first side of the lingual retainer wire to the bonding agent on the lingual side of a second tooth of the at least two teeth.

13. The method according to claim 11, wherein the bonding agent comprises a dental adhesive.

14. The method according to claim 11, wherein the unitary piece of material is comprised of a malleable metal.

15. The method according to claim 14, wherein the malleable metal is comprised of a titanium alloy.

16. The method according to claim 14, wherein the malleable metal is comprised of a stainless steel.

17. A lingual retainer wire in combination with at least two teeth for use in retaining an orthodontic treatment, comprising:
a first side having a solid rectangular configuration; and
a second side positioned opposite the first side and having a solid shape substantially the same as the solid rectangular configuration of the first side;
wherein the first side and the second side are comprised of a unitary piece of material;
wherein the solid rectangular configuration of the first side has a length in a first direction and a height in a second direction substantially perpendicular to the first direction;
wherein the length of the solid rectangular configuration is greater than the height of the rectangular configuration;
wherein the lingual retainer wire further comprises a perimeter edge surrounding the solid rectangular configuration of the first side and positioned to connect the first side with the second side; and
wherein the perimeter edge has a profile that is less than the length and the height of the solid rectangular configuration.

18. The lingual retainer wire according to claim 17, wherein each tooth of the at least two teeth comprises a lingual side, and the lingual retainer wire is configured and dimensioned for adhesion to the lingual side of each of the at least two teeth by a bonding agent.

19. The lingual retainer wire according to claim 18, wherein the lingual retainer wire is configured to hold a space closure between the at least two teeth when the lingual retainer wire is adhered to the lingual side of each of the at least two teeth.

20. The lingual retainer wire according to claim 17, wherein the unitary piece of material is a single solid strand of a flattened wire.
